(19) United States
(12) Patent Application Publication
(10) Pub. No.: US 2017/0210137 A1
(43) Pub. Date: Jul. 27, 2017

(54) IMMISCIBLE FLUID DISTRIBUTION SYSTEM

(71) Applicant: HEWLETT-PACKARD DEVELOPMENT COMPANY, L.P., Houston, TX (US)

(72) Inventors: Jeffrey Allen Wagner, Vancouver, WA (US); Ronald Albert Askeland, San Diego, CA (US); Maria Magdalena Martinez, Sant Cugat del Valles (ES); Paul Joseph Bruinsma, San Diego, CA (US); Sierra Lynn Triebe, Vancouver, WA (US)

(73) Assignee: HEWLETT-PACKARD DEVELOPMENT COMPANY, L.P., Houston, TX (US)

(21) Appl. No.: 15/329,498

(22) PCT Filed: Jul. 30, 2014
(86) PCT No.: PCT/US2014/048970

§ 371 Date: Jan. 26, 2017

(51) Int. Cl. B41J 2/165

(52) U.S. Cl. CPC B41J 2/16552; B41J 2/16505; B41J 2002/16558

(57) ABSTRACT

An immiscible fluid distribution system applies immiscible fluid to the nozzles of a printhead to at least partly cap unused nozzles during printing. A printer subassembly may comprise an immiscible fluid distribution system to apply an immiscible fluid to the surface of a printhead nozzle plate. A method of capping a printhead may comprise applying a layer of immiscible fluid to nozzles of a printhead and selectively ejecting a fluid from a first subset of nozzles while not ejecting fluid from a second subset of nozzles that are at least partially capped with the immiscible fluid.

### BACKGROUND

Inkjet printing devices comprise a printhead that includes a number of chambers. Each of these chambers includes an actuator that ejects an amount of jettable fluid such as ink out of the chamber. The chamber is in fluid communication with a nozzle bore that ends in a nozzle orifice. The jettable fluid is ejected out of the nozzle and onto a substrate to form an image.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a block diagram of a printing system according to one example of the principles described herein

FIG. 2 is a block diagram of a printer according to one example of the principles described herein.

FIG. 3A is a diagram of a printing cartridge comprising a number of nozzles according to one example of the principles described herein.

FIG. 3B is a diagram of a wide array comprising a number of nozzles according to one example of the principles described herein.

FIG. 4 is a block diagram of a side view of a printhead according to one example of the principles described herein.

FIG. 5 is a flowchart showing a method of capping a printhead according to one example of the principles described herein.

Throughout the drawings, identical reference numbers designate similar, but not necessarily identical, elements.

### DETAILED DESCRIPTION

As described above, inkjet devices comprise a number of nozzles from which a jettable fluid is ejected. In one example, a resistor may be placed in each chamber such that when it is heated, a bubble is formed that pushes out an amount of jettable fluid based on the size of the cavity. In another example, a piezoelectric device may be used to eject the jettable fluid out of the chamber by applying an electrical current to a piezoelectric material. In either case, the jettable fluid is ejected through a nozzle bore and nozzle orifice generally defining the nozzle.

After the ejection, an amount of jettable fluid may be left in the area of the nozzle, Additionally, an amount of jettable fluid may be maintained in the nozzle bore in anticipation for future ejection onto the substrate. A situation in which the nozzle is unused for more than approximately 5 minutes may be termed “long term decap”. In another example, long term decap may exist at any time starting from 8 seconds and longer.

Noticeable defects caused by term decap can be seen in the behavior of the inkjet printing device over time. In one example, some evaporation of the jettable fluids within, for example, an ink via interaction with atmosphere may occur. The evaporation of some of the components of the jettable fluid may cause changes to the characteristics of the jettable fluid.

The above described evaporation may be delayed somewhat through the use of physical caps that are placed over the nozzles of the printhead. These physical caps use an additional mechanical device to remove them from the nozzles before printing and reapply them after printing. The use of the mechanical device may limit the time that the printer may be used because the removal and application of the caps takes the printhead away from printing on a substrate.

In the present specification and in the appended claims, the term “short term decap” is meant to be understood broadly as any situation in which a nozzle of an inkjet device is exposed to atmosphere while the inkjet device is printing onto a substrate. In one example, the exposure to atmosphere during a short term decap also comprises a situation in which the nozzles are not serviced. In one example, the duration of a short term cap may be less than 8 seconds. “Fly-by spits” and “spit-on-page” are two tools used in inkjet printers to “refresh” nozzles in the middle of a job in order to prevent the effects of short term decap. However, the use of these methods may result in increases in jettable fluid waste and add further wear and tear to the inkjet components as well as other disadvantages.

The present specification therefore describes printer may comprise a printhead comprising a number of nozzles, an immiscible fluid distribution system to apply immiscible fluid to the nozzles and a processor to instruct the immiscible fluid distribution system to apply immiscible fluid to the nozzles to at least partly cap unused nozzles during printing.

The present specification further describes a printer subassembly may comprise an immiscible fluid distribution system to apply an immiscible fluid to the surface of a printhead nozzle plate.

Additionally, the present specification describes a method of capping a printhead that comprises applying a layer of immiscible fluid to nozzles of a printhead and selectively ejecting a jettable fluid from a first subset of nozzles while not ejecting jettable fluid from a second subset of nozzles that are at least partially capped with the immiscible fluid.

As used in the present specification and in the appended claims, the term “fluid” is meant to be understood broadly as any substance that continually deforms under an applied shear stress. In one example, a fluid may be a jettable fluid. As used in the present specification and in the appended claims, the term “jettable fluid” is meant to be understood broadly as any fluid that may be rejected out of a nozzle on a printhead. In one example, the jettable fluid may be a pharmaceutical. In another example, the jettable fluid may be an ink. In another example, the jettable fluid may be a liquid.

Additionally, as used in the present specification and in the appended claims, the term “substrate” is meant to be understood broadly as any surface onto which a jettable fluid ejected from a nozzle of a printer may be deposited. In one example, the substrate may be paper. In another example, the substrate may be en edible substrate In yet one more example, the substrate may be a medicinal pill. In again another example, the substrate may be a three-dimensional printing powder. In yet another example, the substrate may be tissue or an array of containers to receive pharmaceutical fluids.

Also, as used in the present specification and in the appended claims, the term “printer” is meant to be understood broadly as any device capable of selectively placing a jettable fluid onto a substrate. In one example the printer is an inkjet printer. In another example, the printer is a three-dimensional printer. In yet another example, the printer is a digital titration device.

Further, as used in the present specification and in the appended claims, the term “subset” is meant to be understood broadly as any positive number of an object less than the total. For example, where a printhead comprises 10 dies, a subset of those dies would include 9 or less. Similarly, where a die comprises 1200 nozzles, a subset of nozzles comprises 1199 or less nozzles.

Still further, as used in the present specification and in the appended claims, the term “immiscible fluid” is meant to be understood broadly as any fluid that does not mix with another fluid. In one example, the immiscible fluid does not mix with the jettable fluid such as ink. In another example, the immiscible fluid does not chemically react with a jettable fluid present in a printer cartridge.

Even further, as used in the present specification and in the appended claims, the term “printhead” is meant to be understood broadly as any portion of a printer that interfaces with a substrate to deposit an amount of jettable fluid onto the substrate via a number of nozzles.

Even further, as used in the present specification and in the appended claims, the term “page-wide area printhead” is meant to be understood broadly as any printhead that has a width that is equal to or larger than a sheet of substrate.

Still further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an example” or similar language means that a particular feature, structure, or characteristic described in connection with that example is included as described, but may not be included in other examples.

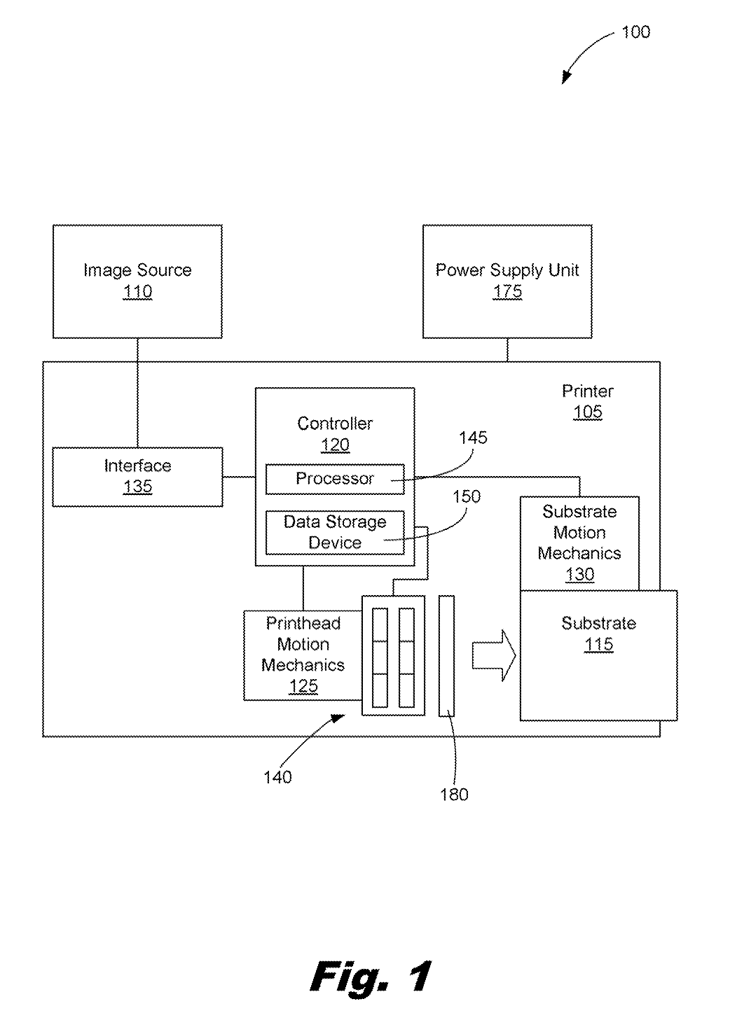

Turning now to FIG. 1 a block diagram of a printing system (100) according to one example described herein is shown. The printing system (100) may comprise a printer (105), an image source (110), and a substrate (115). The printer (105) may comprise a controller (120), printhead motion mechanics (125), substrate motion mechanics (130), an interface (135), and a printhead (140). The controller (120) may comprise a processor (145) and a data storage device (150). Each of these will now be described in more detail.

The printer (105) may comprise an interface (135) to interface with an image source (110). The interface (135) may be a wired or wireless connection connecting the printer (105) to the image source (110). The image source may be any source from which the printer (105) may receive data describing a print job to be executed by the controller (120) of the printer (105) in order print an image onto the substrate (115). In one example, the image source may be a computing device in communication with the printer (105).

The interface (135) enables the printer (105) and specifically the processor (145) to interface with various hardware elements, such as the image source (110), external and internal to the printer (105). For example, the interface (135) may interface with an input or output device such as, for example, display device, a mouse, or a keyboard. The interface (135) may also provide access to other external devices such as an external storage device, a number of network devices such as, for example, servers, switches, and routers, client devices, other types of computing devices, and combinations thereof.

The processor (145) may include the hardware architecture to retrieve executable code from the data storage device (150) and execute the executable code. The executable code may, when executed by the processor (145), cause the processor (145) to implement at least the functionality of printing on the substrate (115), and actuating the printhead and substrate motion mechanics (125, 130), according to the methods of the present specification described herein. The executable code may, when executed by the processor (145), cause the processor (145) to implement the functionality of providing instructions to the power supply unit (175) such that the power supply unit (175) provides power to the printhead (140) to eject a jettable fluid from a number of nozzles. In one example, the number of nozzles fired may be a number less than the total number of nozzles available and defined on the printhead (140).

The data storage device (150) may store data such as executable program code that is executed by the processor (145) or other processing device. The data storage device (150) may specifically store computer code representing a number of applications that the processor (145) executes to implement at least the functionality described herein.

The data storage device (150) may include various types of memory modules, including volatile and nonvolatile memory. For example, the data storage device (150) of the present example includes Random Access Memory (RAM), Read Only Memory (ROM), and Hard Disk Drive (HDD) memory. Many other types of memory may also be utilized, and the present specification contemplates the use of many varying type(s) of memory in the data storage device (150) as may suit a particular application of the principles described herein. In certain examples, different types of memory in the data storage device (150) may be used for different data storage needs. For example, in certain examples the processor (145) may boot from Read Only Memory (ROM) (150), maintain nonvolatile storage in the Hard Disk Drive (HDD) memory, and execute program code stored in Random Access Memory (RAM).

Generally, the data storage device (150) may comprise a computer readable medium, a computer readable storage medium, or a non-transitory computer readable medium, among others. For example, the data storage device (150) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device.

The printhead and substrate motion mechanics (125, 130) comprise mechanical devices that may move the printhead (140) and substrate (115) respectively. Instructions to move the printhead (140) and substrate (115) may be received and processed by the controller (120) and signals may be sent to the printhead (140) and substrate motion mechanics (130) from the controller (120).

The printhead (140) may cause an amount of jettable fluid to be ejected onto a substrate (115) in order to form some image on the substrate (115). The printhead (140) may be any type of jettable fluid depositing such as an inkjet printhead, a thermal inkjet printhead, a piezoelectric inkjet printhead, among others. Consequently, the present description contemplates the use of the immiscible fluid and immiscible fluid distribution system (180) described below in connection with any printing device that uses any type of printhead.

The printing system (100) may further comprise an immiscible fluid distribution system (180). The immiscible fluid distribution system (180) may be placed inline or offline from the printhead (140) and may be made accessible to the printhead (140). The immiscible fluid distribution system (180), as will be discussed in more detail below, applies a layer of immiscible fluid to a nozzle plate of the printhead (140). In one example, the immiscible fluid distribution system (180) may move to the printhead (140) in order to apply the layer of immiscible fluid to the printhead (140). In another example, the printhead (140) may move to the immiscible fluid distribution system (180) in order to receive an application of the layer of immiscible fluid as described herein.

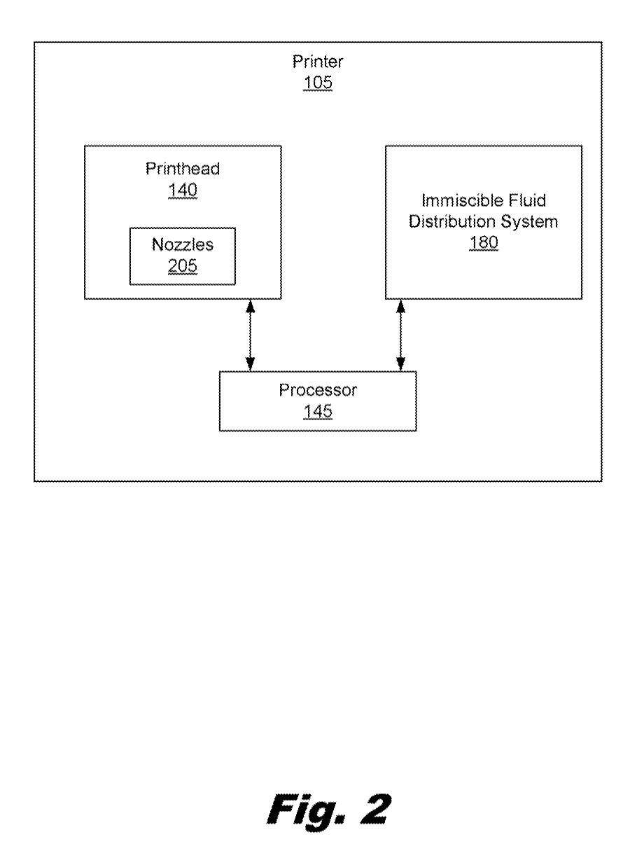

Further details of the printer in the printing system are now discussed in reference to FIG. 2. FIG. 2 is a block diagram of a printer according to one example of the principles described herein. The printer (105) comprises a printhead (140) and an immiscible fluid distribution system (180). The printhead (140) may comprise a number of nozzles (205). In one example, the number of nozzles are grouped together forming a single die of nozzles. The printer (105) may further comprise a processor (145) in electrical communication with the printhead (140), nozzles (205), and immiscible fluid distribution system (180). The immiscible fluid distribution system (180) may comprise any type of system that applies an immiscible fluid to the nozzle plate of a printhead (140) thereby capping, at least partially, a nozzle located thereon. In one example, the nozzles may be fully capped by a layer of immiscible fluid. In another example, not all unused nozzles are capped. For example, most nozzles are capped. In again other examples, each or some of the nozzles are partly capped. In one example, one-half or less of the nozzle bores are covered with the immiscible fluid. It was found that said partial capping can also produce a sufficient capping effect, i.e. inhibiting the decapping effects. In one example, the immiscible fluid distribution system (180) may comprise a roller that applies an amount of immiscible fluid to the nozzle plate of the printhead (140). In another example, the immiscible fluid distribution system (180) may comprise a web-wipe and wiper; the web-wipe being impregnated with the immiscible liquid such that when the web-wipe is placed into contact with the nozzle plate of the printhead (140) the wiper squeegees out an amount of immiscible fluid onto the surface of the nozzle plate.

In yet another example, the immiscible fluid distribution system (180) may use a rubber wiper to apply an amount of immiscible fluid onto the nozzle plate. In still another example, the immiscible fluid distribution system (180) is a try into which an amount of immiscible fluid is kept. In this example, the printhead (140) is brought into contact with the immiscible fluid such that the nozzle plate of the printhead (140) is coated with immiscible fluid. In another example, the immiscible fluid distribution system (180) uses a vapor deposition chamber such that presentation of the printhead (140) into the vapor deposition chamber causes an immiscible fluid to settle onto the surface of the nozzle plate of the printhead (140) after the immiscible fluid has been vaporized. In still another example, the immiscible fluid distribution system (180) comprises a number of high pressure nozzles through which an amount of immiscible fluid is sprayed onto the nozzle plate of the printhead (140).

In still another example, a number of channels may be formed in the printhead with each channel terminating with a microvalve. The channels may be filled with immiscible fluid to be dispensed on the surface of the nozzle plate. In one example, the immiscible fluid may be driven through the channels using an electric field difference. The valves may also be driven by a number of electrodes.

The processor (145) may direct the immiscible fluid distribution system (180) and the printhead (140) to move relative to each other such that they come in contact with each other. During contact, the processor (145) may execute computer code that directs the immiscible fluid distribution system (180) to apply the immiscible fluid as described above.

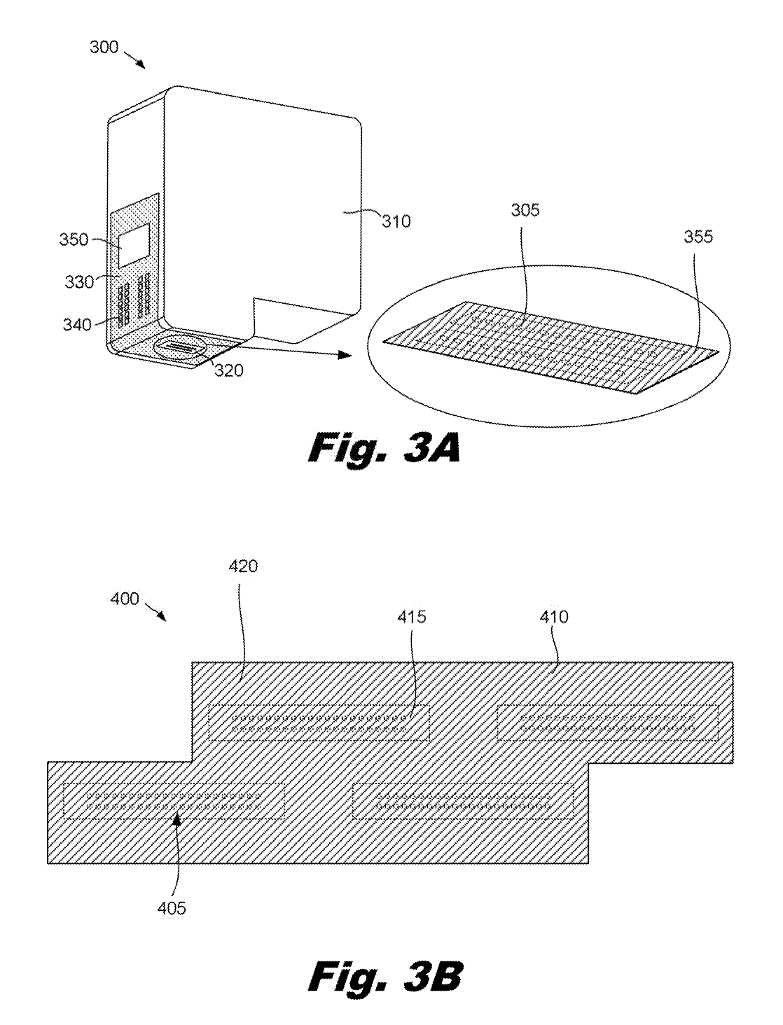

As discussed above, the printhead (140) may comprise a number of nozzles. In some examples, the printhead (140) may be broken up into a number of print dies with each die comprising a number of nozzles. The printhead (140) may be any type of printhead including, for example, a cartridge or a wide array. FIGS. 3A and 3B show the physical layout of these two types of printheads respectively. The examples shown in FIGS. 2A and 2B are not meant to limit the present description. Instead, various types of printheads may be used in conjunction with the present principles described herein.

FIG. 3A is a block diagram of a printing cartridge (300) comprising a number of nozzles (305) according to one example of the principles described herein. The cartridge (300) comprises a jettable fluid reservoir (310), a die (320), a flexible cable (330), conductive pads (340), and a memory chip (350). The flexible cable (330) is adhered to two sides of the cartridge (300) and contains traces that electrically connect the memory (350) and die (320) with the conductive pads (340).

The cartridge (300) may be installed into a cradle that is integral to the carriage of a printer (FIG. 1, 105). When the cartridge is correctly installed, the conductive pads (340) are pressed against corresponding electrical contacts in the cradle, allowing the printer (FIG. 1, 105) to communicate with, and control the electrical functions of, the cartridge (300). For example, the conductive pads (340) allow the printer (FIG. 1, 105) to access and write to the fluid-jet memory chip (350).

The memory chip (340) may contain a variety of information including the type of jettable fluid cartridge, the kind of jettable fluid contained in the cartridge, an estimate of the amount of jettable fluid remaining in the jettable fluid reservoir (310), calibration data, error information, and other data. In one example, the memory chip (340) may comprise information regarding when the cartridge (300) should be maintained. As described herein, the maintenance may comprise applying a layer of immiscible fluid (355) to the surface of the die (320). The printer (FIG. 1, 105) can take appropriate action based on the information contained in the cartridge memory (340) such as notifying the user that the jettable fluid supply is low or altering printing routines to maintain image quality. The cartridge memory (340) is shown as a separate element that is distinct from the die (320). However, according to one example, the die (320) may contain the memory in addition to the elements used to dispensing the ink.

To create an image, the printer moves the carriage containing the cartridge over a piece of print medium. At appropriate times, the printer sends electrical signals to the fluid-jet cartridge (300) via the electrical contacts in the cradle. The electrical signals pass through the conductive pads (340) and are routed through the flexible cable (330) to the die (320). The die (320) then ejects a small droplet of jettable fluid from the reservoir (310) onto the surface of the substrate. These droplets combine to form an image on the surface of the substrate (FIG. 1, 115).

The die (320) may comprise any number of nozzles (305). In an example where the jettable fluid is an ink, a first subset of nozzles (305) may eject a first color of ink while a second subset of nozzles (305) may eject a second color of ink. Additional groups of nozzles (305) may be reserved for additional colors of ink. During operation, the immiscible fluid distribution system (FIG. 1, 180) may distribute a layer of immiscible fluid (355) onto the die (320). In one example, the immiscible fluid (355) may cover each nozzle (305) of the die (320) such that ambient air does not come in contact with the immiscible fluid located within the nozzles (305) or nozzle bore. In another example, the layer of immiscible fluid may, at least, partially cover or cap any individual nozzle. The immiscible fluid may remain on the die (320) after any of the nozzles (305) have been fired. In one example, the immiscible fluid may be formulated such that upon ejection of the jettable fluid out of the nozzle (305), the immiscible fluid reforms a layer over the nozzle (305). This process may repeat any number of times such that the nozzle (305) has an immiscible fluid layer formed over it between nozzle (305) firings.

The immiscible fluid may be formed such that the above advantages may be realized. In one example, the immiscible fluid has a viscosity of 0.8 to 5 centipoise (cp) (0.01-0.05 kg*m⁻¹*s⁻¹) In another example, the immiscible fluid has a viscosity of 1 to 2 centipoise. In yet another example, the immiscible fluid has a viscosity of 1.5457 cp.

In one example, the surface tension is 18-35 mN/m. In another example, the immiscible fluid has a surface tension of 22-27 mN/m. In yet another example, the surface tension is 25.1 mN/m. The surface tension of the immiscible fluid sufficiently wets the surface of the die (320) while still allowing the layer of immiscible fluid to, in one example, reform over the nozzle (305) after firing. The immiscible fluid may spread sufficiently over the die (320) but not be too far so as to allow exposure in the jettable fluid to ambient air and evaporation. The viscosity may also be low enough so as to not plug any of the nozzle bores thereby preventing firing of jettable fluid through the immiscible fluid layer.

In one example, the molecular weight of the immiscible fluid is 130 to 300 g/mol. In another example, the immiscible fluid has a molecular weight of 165 to 177 g/mol. In yet one example, the molecular weight of the immiscible fluid is 171 g/mol.

In one example, the immiscible fluid is soluble to 200 part per million (ppm) in 20° Celsius water at 1 atm. In one example, the density of the immiscible fluid at 10° C. is 0.6 to 1.2 g/cm³. In another example, the density of the immiscible fluid at 10° C. is 0.7 to 0.8 g/cm³. In yet another example, the density of the immiscible fluid at 15° C. is 0.779 g/cm³. In one example, the boiling point of the immiscible fluid is within environmental range while also being able to jet under, for example, thermal-ink jet condition. In this example, the boiling point may be between 185 and 260° C. In another example, the boiling point of the immiscible fluid is between 188° C. to 192° C. In yet another example, the boiling point is 190° C.

In one example, the immiscible fluid is a paraffin liquid or an isoparaffin liquid such as Isopar™. In another example, the immiscible fluid may be Isopar™ J, Isopar™ K, Isopar™ L, Isopar™ M, Isopar™ P, polypropylene glycol (PPG), or combinations thereof. In one example, the immiscible fluid is Isopar™ L.

Additionally, the immiscible fluid does not react with the jettable fluid present in the firing chambers connected to the nozzle bores and nozzles. Consequently, in the present specification and in the appended claims, the term “immiscible fluid” is meant to be understood broadly as any fluid that is incapable of mixing with another fluid. As such, in one example, the immiscible fluid forms a coating over the fluid present in the nozzle bore sealing the jettable fluid in the immediate portions of the nozzle and nozzle bore interface. The immiscible fluid is also substantially non-evaporative or substantially nonvolatile such that it does not evaporate when subject to ambient air or temperatures. In one example, the immiscible fluid is less volatile as compared to the jettable fluid within the nozzles. In one example, the evaporation rate of the immiscible fluid is 6 with n-BuAc equal to 100.

In another example, the characteristics of the immiscible fluid may allow the immiscible fluid to flow further into the nozzle bore and into the firing chamber. However, in one example, due to the surface tension properties of the immiscible fluid, the immiscible fluid will still form a seal over the jettable fluid present in the firing chamber by adhering to the surface of the nozzle bore while not preventing jetting operation of the piezo-electric or thermal ink jet devices within the chamber.

Still further, in one example, the immiscible fluid may be hydrophobic. In this example, when the layer of immiscible fluid is deposited over the printhead (320) and a jettable fluid chamber associated with a nozzle bore and nozzle engages in a firing procedure, the jettable fluid separates the layer of immiscible fluid as it exists from the nozzle. After the jettable fluid has been ejected from the nozzle, the immiscible fluid rebounds to once again seal and cover the nozzle due to the surface tension property of the immiscible fluid. This process may continue on throughout the printing process or until a new layer of immiscible fluid is deposited over the printhead (320).

FIG. 2B is a diagram of a wide array (400) comprising a number of nozzles (405) according to one example of the principles described herein. The wide array (400) may comprise a carrier (410) and a number of dies (415). The individual nozzles (405) and dies (415) may be communicatively coupled to a controller (FIG. 1, 120) such that each nozzle is selectively activated in order to eject an amount of jettable fluid onto a substrate (FIG. 1, 115). As described above, a layer of immiscible fluid may be deposited over the carrier (410), the dies (415), the nozzles (405), or combinations thereof. The application of the layer of immiscible fluid may be accomplished by the immiscible fluid distribution system (FIG. 1, 180) as described above in connection with FIG. 1,

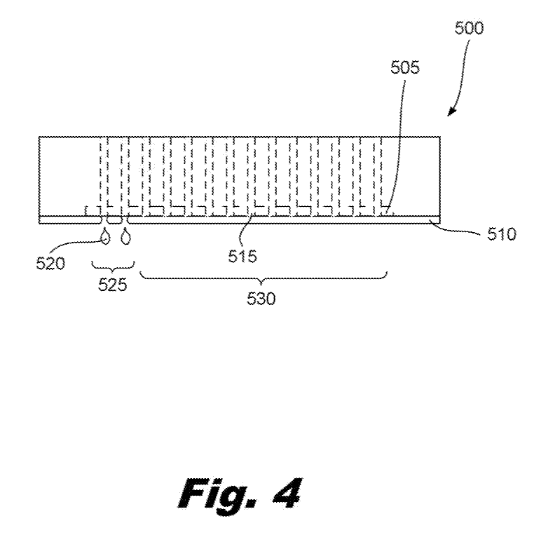

FIG. 4 is a block diagram of a side view of a printhead (500) according to one example of the principles described herein. The printhead (500) also comprises a printhead die (505) similar to that described above in connection with FIGS. 1-3B. In this example, the die (505) is flush with the rest of the body of the printhead (500). In another example, the die (505) is not flush with the rest of the body of the printhead (500). As described above, a layer of immiscible fluid (510) is applied to the surface of the die (505), printhead (500) or combinations thereof covering a number of nozzles (515). The application of the layer of immiscible fluid (510) to the die (505) or nozzle plate covers the individual nozzles (515) preventing the jettable fluid inside the nozzle bores and ejection chambers from evaporating. In one example, the layer of immiscible fluid may be allowed to flow further into the nozzle bore, displacing and amount of jettable fluid present in the nozzle bore. This may be accomplished by creating back pressure in the firing chambers associated with the nozzle bores thereby drawing in an amount of immiscible fluid. The thickness of the layer of immiscible fluid, in one example, may be 0.5 mm or less. In another example, the thickness of the layer of immiscible fluid (410) is 1 micron. In another example, the thickness of the immiscible fluid layer does not prevent the nozzle from being able to eject an amount of jettable fluid out of the nozzle. Consequently, in one example, the thickness of the layer of immiscible fluid is not too thick so as to prevent ejection of the jettable fluid.

As briefly described above. The immiscible fluid prevents the jettable fluid in each nozzle from evaporating. The evaporation of the jettable fluid leaves an amount of non-evaporative substance behind. The non-evaporative substance of the jettable fluid may subsequently block the path of any non-evaporated jettable fluid still in the cartridge. Consequently, the nozzle, nozzle bore, and firing chamber cannot eject an amount of jettable fluid thereby destroying its usefulness. The layer of immiscible fluid prevents this from happening even when the nozzle has fired a number of times. Additionally, because a number of nozzles may not fire at all during any printing cycle, the unfired nozzles are subjected to long-term decap otherwise. When the printing time exceeds the capability of the ink to avoid evaporation related defects, this could cause the unfired nozzles to completely dry out causing those nozzles to be destroyed. Because these nozzles can never be used again without relatively significant cleaning, the use of the immiscible fluid saves time and repair costs.

FIG. 4 further shows ejection of a jettable fluid (520) from a first subset of nozzles (525) while not ejecting jettable fluid from a second subset of nozzles (530); all of the nozzles (525, 530) being at least partially capped with the immiscible fluid. The selective ejection from the first subset of nozzles (525) allows a printer to apply an image to substrate (FIG. 1, 115) while still protecting the second subset of nozzles (530) that are not being used to eject jettable fluid. In one example, after the first subset of nozzles (525) has been fired, the immiscible fluid layer (510) that once covered the nozzles (525) in that subset rebounds to once again cover the first subset of nozzles (525).

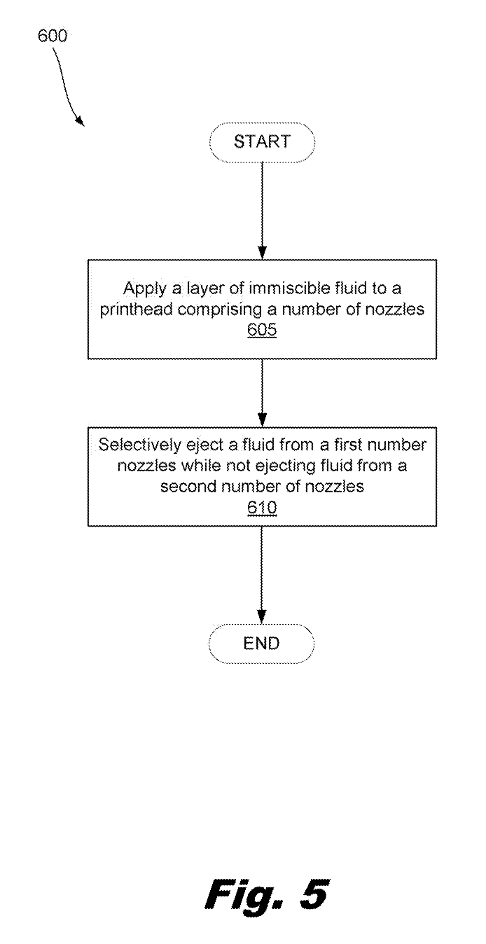

FIG. 5 is a flowchart showing a method (600) of capping a printhead according to one example of the principles described herein. The method may begin with the application (605) of a layer of immiscible fluid on a printhead (FIG. 1, 140). As described above, the application of the immiscible fluid is done by the immiscible fluid distribution system (FIG. 1, 180). The immiscible fluid may be applied to the printhead (FIG. 1, 140) before a printing cycle, during a printing cycle, after a printing cycle, or combinations thereof. In one example, the frequency of the application of the immiscible fluid may be dependent on the viscosity, molecular weight, solubility, surface tension, and fluid density of the immiscible fluid as described above.

The method may continue by selectively ejecting (610) a jettable fluid from a first subset of nozzles (FIG. 3A, 305; FIG. 3B, 405) while not ejecting jettable fluid from a second subset of nozzles (FIG. 3A, 305; FIG. 3B, 405). In one example, the first subset of nozzles (FIG. 3A, 305 FIG. 3B, 405) comprise those nozzles that exist directly over the substrate (FIG. 1, 115) onto which the jettable fluid is to be ejected onto. In this example, the second number of nozzles (FIG. 3A, 305; FIG. 3B, 405) are not directly over the substrate (FIG. 1, 115) because of the size of the substrate (FIG. 1, 115) relative to printhead (FIG. 1, 140), in the example of the wide array shown in FIG. 3B, any number of nozzles (FIG. 2B, 405) may extend past the physical boundaries of the substrate (FIG. 1, 115) as the substrate is passed under the printhead (FIG. 1, 140). Consequently, the printer (FIG. 1, 105) may not cause the firing of certain nozzles (FIG. 3A, 305; FIG. 3B, 405) such that an image is formed on the substrate (FIG. 1, 115) by the first subset of nozzles (FIG. 3A, 305; FIG. 3B, 405) and not onto other surfaces. In the case where a printing cartridge (200) such as that shown in FIG. 3A is used, although the cartridge (FIG. 3A, 300) may move relative to the substrate (FIG. 1, 115), some types of jettable fluid may not be used to form the image. In this example, the jettable fluid may comprise a number of different colors. Where the controller (FIG. 1, 120) has directed the firing of a certain number of nozzles (FIG. 3A, 305; FIG. 3B, 405) comprising certain colors of jettable fluid, other colors will not be used.

The selective ejection (610) of the first and second subset of nozzles (FIG. 3A, 305; FIG. 3B, 405) allows those nozzles (FIG. 3A, 305; FIG. 3B, 405) that are not being used during a printing process to still be used later without an intermediary priming or maintenance procedure to be conducted. This is because, although the second subset of nozzles (FIG. 3A, 305; FIG. 3B, 405) are not being used, the layer of immiscible fluid (FIG. 4, 510) caps and protects the unused jettable fluid within the nozzle, nozzle bore, and firing chamber from evaporation while not in use during what would otherwise be a long term decap. In one example, the replacement of the layer of immiscible fluid (FIG. 4, 510) on the second subset of nozzles may not be conducted after a number of printing processes have been made. In another example, the layer of immiscible fluid (FIG. 4, 510) on the second subset of nozzles may be left capped by an original layer of immiscible fluid (FIG. 4, 510) while other nozzles such as those in the first subset have a new layer of immiscible fluid (FIG. 4, 510) applied thereon. In yet another example, the layer of immiscible fluid (FIG. 4, 510) may be applied to any nozzle that fired once during a printing process. In still another example, the layer of immiscible fluid (FIG. 4. 510) may be applied to any fired nozzle after a number of firings or after a number of printing processes have been completed.

The application of the layer of immiscible fluid (FIG. 4, 510) may be accomplished through the immiscible fluid distribution system (180) and the methods of use described above. In one example, the immiscible fluid distribution system (FIG. 1, 180) may at least partially cap the individual nozzles. In this example, partially capped is meant to be understood as a portion of the nozzle orifice being covered or capped while a portion is not. In another example, the immiscible fluid distribution system (FIG. 1, 180) may cap the nozzle entirely completely leaving no jettable fluid within the nozzle subjected to ambient air. The immiscible distribution system (FIG. 1, 180), may also partially or completely fill the nozzle bore or nozzle chamber.

The present method (600) may be accomplished through the use of a computer program product with the computer program product comprising a computer readable storage medium comprising computer usable program code embodied therewith. In this example, the computer usable program code may comprise computer usable program code to, when executed by a processor, applies a layer of immiscible fluid to a printhead comprising a number of nozzles. Specifically, the controller (FIG. 1, 120) and more specifically the processor (FIG. 1, 145) of the printer (FIG. 1, 105) may direct the immiscible fluid distribution system (FIG. 1, 180) to apply a layer of immiscible fluid onto the printhead (FIG. 1, 140). The computer usable program code may further comprise computer usable program code to, when executed by a processor, selectively eject a jettable fluid from a first subset of nozzles while not ejecting jettable fluid from a second subset of nozzles. Again, in this example, the controller (FIG. 1, 120) and more specifically the processor (FIG. 1, 145) of the printer (FIG. 1, 105), when executing this computer usable program code, may direct the printhead (FIG. 1, 140) to fire a first subset of nozzles (FIG. 3A, 305; FIG. 3B, 405) while directing the printhead (FIG. 1, 140) to not fire a second subset of nozzles (FIG. 3A, 305; FIG. 3B, 405),

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the processor (FIG. 1, 145) of the printer (FIG. 1, 105) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe a system and method of preventing evaporation of a jettable fluid in the nozzles of a printhead by coating the nozzles with an immiscible fluid. The application of the immiscible fluid to the printhead allows a first subset of nozzles to be fired while a second subset of nozzles are not fired. While the first subset of nozzles are firing, the second subset of nozzles are not subjected to any long term decap because they are constantly protected by the layer of immiscible fluid. Additionally, the first subset of nozzles may be fired and still be protected from short term decap as a result of the properties of the immiscible fluid. Specifically, the immiscible fluid may allow a jettable fluid to be fired through it when the nozzle is fired. In one example, after firing, the immiscible fluid reforms a cap over the nozzle due to the specific properties of the immiscible fluid.

The preceding description has been presented to illustrate and describe examples of the principles described This description is not intended to be exhaustive or to limit these principles to any precise form disclosed. Many modifications and variations are possible in light of the above teaching.

What is claimed is:

1. A printer, comprising:
a printhead comprising:
a number of nozzles;
an immiscible fluid distribution system to apply immiscible fluid to the nozzles; and
a processor to instruct the immiscible fluid distribution system to apply immiscible fluid to the nozzles to at least partly cap unused nozzles during printing.

2. The printer of claim 1, in which the immiscible fluid nonvolatile.

3. The printer of claim 1, further comprising selectively ejecting the fluid from a first subset of nozzles through the immiscible fluid.

4. The printer of claim 3, in which ejection of a fluid from the first subset of nozzles causes the immiscible fluid to separate and subsequently rebound to recover the nozzle.

5. The printer of claim 1, in which the immiscible fluid has a surface tension of 18 to 35 mN/m.

6. The printer of claim 1, in which the immiscible fluid has a density of 0.6 to 1.2 g/cm³.

7. The printer of claim 1, in which the immiscible fluid has a molecular weight of 130 to 300 g/mol.

8. The printer of claim which the immiscible fluid has a viscosity of 0.8 to 5 centipoise.

9. A printer subassembly, comprising
an immiscible fluid distribution system to apply an immiscible fluid to the surface of a printhead nozzle plate.

10. The printer subassembly of claim 9, in which the immiscible fluid is an isoparaffin.

11. The printer subassembly of claim 9, further comprising a porous web-wipe and a squeegee in which the immiscible fluid is applied to the nozzle plate when the web-wipe and squeegee come in contact with the nozzle plate.

12. The printer subassembly of claim 9, further comprising a roller in which the immiscible fluid is applied to the nozzle plate when the roller comes in contact with the nozzle plate.

13. The printer subassembly of claim 9, further comprising a wiper blade in which the immiscible fluid is applied to the nozzle plate when the wiper blade comes in contact with the nozzle plate.

14. A method of capping a printhead, comprising;
applying a layer of immiscible fluid to nozzles of a printhead; and
selectively ejecting a fluid from a first subset of nozzles while not ejecting fluid from a second subset of nozzles that are at least partially capped with the immiscible fluid.

15. The method of claim 14, further comprising selectively ejecting the fluid from a first subset of nozzles through the immiscible fluid.
